(19) United States
(12) Patent Application Publication
(10) Pub. No.: US 2025/0076642 A1
(43) Pub. Date: Mar. 6, 2025

(54) EYE TRACKING OPTICAL SYSTEM AND DISPLAY DEVICE

(71) Applicant: Beijing Zitiao Network Technology Co., Ltd., Beijing (CN)

(72) Inventors: Jihe ZHANG, Beijing (CN); Xin LI, Beijing (CN); Zishang WANG, Beijing (CN)

(21) Appl. No.: 18/821,408

(22) Filed: Aug. 30, 2024

(30) Foreign Application Priority Data
Aug. 30, 2023 (CN) 202311110264.8

(51) Int. Cl. G02B 27/00; G02B 27/12; G02B 27/14; G02F 1/1335; G06F 1/16

(52) U.S. Cl. CPC G02B 27/0093; G02F 1/133528; G06F 1/163; G02B 27/126; G02B 27/141

(57) ABSTRACT

The disclosure provides an eye tracking optical system and a display device, and the eye tracking optical system includes a display panel module, configured to emit a first light to a human eye; an eye tracking module, provided on a light emitting side of the display panel module, including a light reflection unit and a light reception unit, where the light reflection unit is configured to receive a second light reflected by the human eye and couple the second light to the light reception unit, the light reception unit is configured to receive the incident second light to perform eye tracking, and the first light and the second light are different lights.

### CROSS-REFERENCE

This application claims priority to Chinese Patent Application No. 202311110264.8 filed on Aug. 30, 2023, and entitled “EYE TRACKING OPTICAL SYSTEM AND DISPLAY DEVICE”.

### FIELD

The present disclosure relates to the field of display technologies, and in particular, to an eye tracking optical system and a display device.

### BACKGROUND

Presently, augmented reality (AR) and/or virtual reality (VR) systems may generate three-dimensional (3D) immersive environments. A user may interact with the 3D virtual immersive environment through various display devices. The near-eye display optical system has the characteristics of small volume, light weight, capability of three-dimensional display and the like, and has good development prospects.

When the user uses the VR product and the AR product, the left eye and the right eye may see the same scene at different views respectively, therefore generates parallax; then the brain integrates the images for stereoscopic display. An eye gaze point position or a sight line is tracked during display process, and the eye gaze point position may be better adapted for picture display.

### SUMMARY

The present disclosure aims at solving at least one of the technical problems in the related art to some extent. Therefore, an objective of the present disclosure is to provide an eye tracking optical system and a display device, which may track the eye and improve user experience.

In a first respect of the present disclosure, an eye tracking optical system is provided, including: a display panel module, configured to emit a first light to a human eye; an eye tracking module, provided on a light emitting side of the display panel module, including a light reflection unit and a light reception unit, where the light reflection unit is configured to receive a second light reflected by the human eye and couple the second light to the light reception unit, the light reception unit is configured to receive the incident second light to perform eye tracking, and the first light and the second light are different lights.

According to an embodiment of the present disclosure, the first light is a first polarized light, the second light is a second polarized light, and a polarization direction of the first polarized light and a polarization direction of the second polarized light are perpendicular; the light reflection unit includes a first reflection interface, the first reflection interface includes a plurality layers of dielectric films, and the first reflection interface is configured to reflect the second polarized light and transmit the first polarized light.

According to an embodiment of the present disclosure, the display panel module includes a display panel and a polarizer provided on a side of the display panel close to a light exit side, and the polarizer is configured to convert a light of the display panel into the first polarized light.

According to an embodiment of the present disclosure, the first reflection interface is obliquely provided relative to the display panel, the first reflection interface further includes a first prism and a second prism configured to fix the first reflection interface, the first prism and the second prism are right-angled triangular prisms, an inclined surface of the first prism and an inclined surface of the second prism are oppositely provided, and the first reflection interface is fixed on the inclined surface of the first prism or the second prism.

According to an embodiment of the present disclosure, the eye tracking optical system further includes a light emitting unit, configured to emit the second light to the human eye, where the second light is an infrared light; the light emitting unit is provided inside the display panel module or on a light exit side of the display panel module.

According to an embodiment of the present disclosure, the light reflection unit includes a second reflection interface, the second reflection interface includes a dichroic optical coating, and the second reflection interface is configured to reflect the infrared light and transmit a visible light.

According to an embodiment of the present disclosure, the second reflection interface is obliquely provided relative to the display panel, the light reflection unit further includes a third prism and a fourth prism configured to fix the second reflection interface, the third prism and the fourth prism are right-angled triangular prisms, an inclined surface of the third prism and an inclined surface of the fourth prism are oppositely provided, and the second reflection interface is fixed on the inclined surfaces of the third prism and the fourth prism.

According to an embodiment of the present disclosure, the eye tracking optical system further includes a housing, including a lens barrel and a first end and a second end oppositely provided on the lens barrel, the first end is an end close to the human eye, the display panel module is fixedly provided at the second end, and the light reception unit and the light reflection unit are both fixedly provided on the lens barrel.

According to an embodiment of the present disclosure, the lens barrel is provided with an accommodating cavity for accommodating the light reflection unit, the accommodating cavity protrudes from an inner wall to an outer wall of the lens barrel, and a field angle between the human eye and the display panel module is less than or equal to a field angle between the human eye and the light reflection unit.

According to an embodiment of the present disclosure, the light reflection unit and the light reception unit are located on a same side of the lens barrel, and the light reception unit is fixedly provided on an outer side of the light reflection unit through an optical adhesive.

According to an embodiment of the present disclosure, the light reflection unit and the light reception unit are located on two opposite sides of the lens barrel in a radial direction, the light reception unit is fixedly provided on an outer wall of the lens barrel, and a light transmitting hole for transmitting the second light is provided on the lens barrel.

According to an embodiment of the present disclosure, the light reflection unit is provided along a circumferential direction of an inner wall of the housing, and an orthographic projection of the light reflection unit on the display panel module coincides with an orthographic projection of the inner wall on the display panel module.

According to an embodiment of the present disclosure, the eye tracking optical system further includes a lens module, provided between the eye tracking module and the human eye, where the lens module includes at least one lens.

In another respect of the present disclosure, a display device is provided, including at least one eye tracking optical system as described in any of the above. The light reflection unit collects the light reflected by the human eye through selection of a specific light and does not affect the original first light emitted from the display panel module into the human eye, therefore the normal display requirement may be effectively met, and eye tracking of the user is completed based on a human eye image collected by the light reception unit.

### BRIEF DESCRIPTION OF DRAWINGS

The above and/or additional aspects and effects of the present disclosure will become apparent and readily understood from the description of the embodiments in conjunction with the following drawings, where:

FIG. 1 is a first schematic structural diagram of an eye tracking optical system according to an embodiment of the present disclosure;

FIG. 2 is a second schematic structural diagram of an eye tracking optical system according to an embodiment of the present disclosure;

FIG. 3 is a third schematic structural diagram of an eye tracking optical system according to an embodiment of the present disclosure;

FIG. 4 is a fourth schematic structural diagram of an eye tracking optical system according to an embodiment of the present disclosure;

FIG. 5 is a fifth schematic structural diagram of an eye tracking optical system according to an embodiment of the present disclosure; and

FIG. 6 is a sixth schematic structural diagram of an eye tracking optical system according to an embodiment of the present disclosure.

### DETAILED DESCRIPTION

The solutions of the present disclosure will be explained below with reference to the embodiments. It will be understood by those skilled in the art that the following examples are for illustrative purposes only and should not be construed as limiting the scope of the present disclosure. The specific techniques or conditions that are not noted in the embodiments should be performed according to the techniques or conditions described as in literature in the art or according to the product specification. The present disclosure is described below with reference to specific embodiments, and it should be noted that these embodiments are merely illustrative and do not limit the present disclosure in any way.

The embodiment of the disclosure provides a display device which is configured to be worn on the head of a user, and at least one eye tracking optical system is provided on the display device for eye tracking. The display device may be a head-mounted display device, for example, the display device may be an electronic product integrating digital contents and reality scenes together such as augmented reality (AR) glasses, AR helmets, virtual reality (VR) glasses, VR helmets, mixed reality (MR) glasses, MR helmets, and the like. The display device may also not be worn on the head. The present disclosure is specifically described by using an example in which the display device are VR glasses.

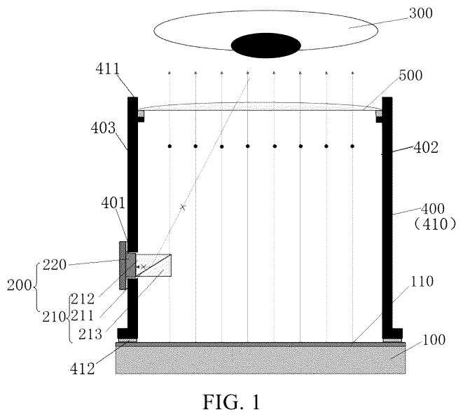

Referring to FIG. 1, an embodiment of the present disclosure provides an eye tracking optical system, including:
a display panel module 100, configured to emit a first light to a human eye 300.
an eye tracking module 200 provided on a light exit side of the display panel module 100, including a light reflection unit 210 and a light reception unit 220, where the light reflection unit 210 is configured to receive a second light reflected by the human eye 300 and couple the second light to the light reception unit 220, and the light reception unit 220 is configured to receive the incident second light to perform eye tracking, and the first light and the second light are different lights.

In the eye tracking optical system provided in the embodiment of the present disclosure, the light reflection unit 210 collects the light reflected by the human eye 300 through selection of a specific light and does not affect the original first light emitted from the display panel module 100 into the human eye, therefore the normal display requirement may be effectively met, and eye tracking of the user is completed based on a human eye image collected by the light reception unit 220.

In an embodiment of the present disclosure, the first light is a first polarized light, the second light is a second polarized light, and polarization directions of the first polarized light and the second polarized light are perpendicular; the light reflection unit 210 includes a first reflection interface 211, and the first reflection interface 211 is configured to reflect the second polarized light and transmit the first polarized light. In each schematic diagram of light in various embodiments of the present disclosure, the first light is represented by “^{⋅}”, and the second light is represented by “^{x}”.

In the present disclosure, the first polarized light may be one of a parallel polarized (p-polarized) light and a senkrencht (perpendicular) polarized (s-polarized) light, and the second polarized light may be another one of the p-polarized light and the s-polarized light. In the embodiment of the present disclosure, the first polarized light being the p-polarized light and the second polarized light being the s-polarized light is taken for example for description. It should be clear to those skilled in the art that the s-polarized light refers to a polarized light which polarization direction is perpendicular to a propagation plane, and the p-polarized light refers to a polarized light which polarization direction is in the propagation plane.

The display panel module 100 is configured to display a picture to a user, the display panel module 100 includes a display panel, the type of the display panel module 100 is not limited in the present disclosure, and the display panel module 100 may be any of a liquid crystal display (LCD) display panel module 100, an organic light emitting diode (OLED) display panel module 100, a micro OLED display panel module 100, and a mini LED display panel module 100; or may be a digital light processing (DLP) display panel module 100; or may be a liquid crystal on silicon (LCOS) display panel module 100. In addition, the display panel module 100 may be a flexible screen or a rigid screen (i.e., a non-flexible screen). In practical applications, it may be selected according to user requirements. In the present disclosure, the liquid crystal display panel module 100 is exemplarily described.

The display panel module 100 includes a polarizer 110 provided on a light exit side of the display panel, and the polarizer 110 is configured to convert a light of the display panel into first polarized light and emit the first polarized light. The polarizer 110 may be an absorptive polarizer 110, and a transmission axis of the polarizer 110 is parallel to a polarization direction of the first polarized light. In other embodiments, other polarization conversion layers may also be used on the display panel module 100, as long as the light emitted from the display panel module 100 may be converted into the first polarized light. The stray light may be absorbed through the polarizer, in particular, the second polarized light incident to the polarizer is absorbed, secondary reflection and the like are prevented from entering the light reflection unit 210 to be received by the light reception unit 220, and then the eye tracking precision is affected.

It may be understood that, due to the phenomena of irregular reflection, diffuse reflection and the like of the human eye 300, a light such as ambient light may have the first polarized light and the second polarized light after being reflected by the human eye 300. In the present disclosure, the light reflection unit 210 only receives the second polarized light reflected by the human eye 300, which is different from the first polarized light reflected by the display panel module 100, which may prevent the first polarized light directly emitted by the display panel module 100 or other environmental lights that has undergone a plurality of reflections from entering the light reflection unit 210, and then being reflected into the light reception unit 220, affecting the eye tracking effect or the display effect of the first polarized light emitted by the display panel module 100 entering the human eye 300.

In the present disclosure, the light reflection unit 210 may be a polarization beam splitter (PBS), the first reflective interface 211 is provided on the PBS, the first reflective interface 211 may be a plurality layers of dielectric films, the second polarized light may be reflected, and the first polarized light may be transmitted.

In the present disclosure, the first reflection interface 211 is obliquely provided relative to the display panel 100. In some embodiments, the first reflective interface 211 further includes a first prism 212 and a second prism 213 configured to fix the first reflective interface 211, the first prism 212 and the second prism 213 are right-angled triangular prisms, an inclined surface of the first prism 212 and an inclined surface of the second prism 213 are oppositely provided, and the first reflective interface 211 is fixed on the inclined surface of the first prism 212 or the second prism 213. The first prism 212 and the second prism 213 may be high precision right-angled prism fixed by gluing, where the inclined surface of one prism thereof is plated with the first reflection interface 211 of the plurality of dielectric films, and based on a position of the light reflection unit 210, an angle between the light reflection unit 210 and the display panel module 100 may be provided differently.

The first prism 212 is provided on a side close to the human eye 300, and the second prism 213 is provided on a side close to the display panel module 100. The first reflection interface 211 may transmit the first polarized light and reflect the second polarized light, a lower surface (a straight corner surface) of the second prism 213 is a light incident surface of the first polarized light emitted by the display panel module 100, and after entering the second prism 213, the first polarized light is transmitted from the inclined surface and transmitted from an upper surface (a straight corner surface) of the first prism 212; the upper surface of the first prism 212 is the light incident surface of the second polarized light reflected by the human eye 300, and the second polarized light is totally reflected by the first reflective interface 211 of the inclined surface after entering the first prism 212, and is coupled to the light reception unit 220 from the light emitting surface (another straight corner surface) of the first prism 212. It should be noted that the first reflective interface 211 may be a plurality of dielectric films or may be any or a combination of several gratings such as a surface-relief grating, a bulk holographic grating, a controllable nano-grating (for example, a liquid crystal grating or a polymer dispersed liquid crystal (PDLC) grating), and may be specifically determined based on actual conditions, which is not limited in the embodiments of the present disclosure.

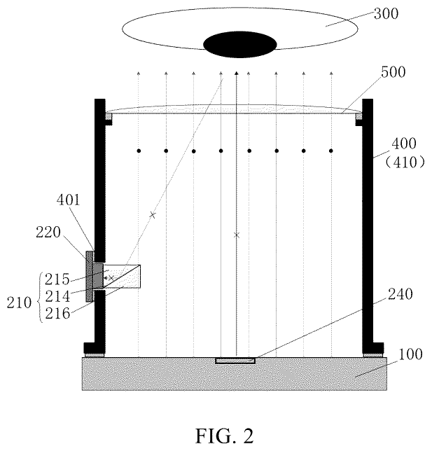

Referring to FIG. 2, in another embodiment of the present disclosure, the eye tracking optical system further includes a light emitting unit 240, configured to emit the second light to the human eye 300, where the second light is an infrared light; the light emitting unit 240 is provided inside the display panel module 100 or on a light exit side of the display panel module 100.

The light emitting unit 240 provided in the embodiment of the present disclosure is an infrared light source, and transmits an infrared light to the human eye 300, which may avoid affecting the visual effect of the eye. It may be understood that, in a suitable case, invisible lights in other wavelength ranges may also be selected as the second light.

The light emitting unit 240 provided in the embodiment of the present disclosure may include at least one light emitting source; when the light source device includes a plurality of light emitting sources, the plurality of light emitting sources may be arranged in a preset manner, for example, arranged in a triangular manner, arranged in a linear manner, and the like; the light emitting unit 240 may be manufactured on the display panel module 100 or may be mounted on a housing 400, which is not specifically limited in the present disclosure.

It may be understood that, the visible light emitted by the display panel module 100 in some embodiments may be directly used for display without providing the polarizer 110. That is, unlike the display panel module 100 shown in FIG. 1, the display panel module 100 in this embodiment does not include the polarizer 110, and therefore, the first light may be visible. It should be noted that the display panel module 100 may also include the polarizer 110, which is a circular polarizer to eliminate surface reflection and the like to improve the display effect; or the polarizer 110 is a linear polarizer, and the first light may be a polarized light such as the p-polarized light or the s-polarized light; or the polarizer 110 is a combination of the linear polarizer and the circular polarizer to match the optical lens architecture of a folded optical path. In an embodiment of the present disclosure, the first light is a visible light, and the second light is an infrared light.

Correspondingly, the light reflection unit 210 includes a second reflecting interface 214, the second reflecting interface 214 includes a dichroic optical coating configured to reflect the infrared light and transmit the visible light; the light reception unit 220 may be an infrared sensor, for example, a charge coupled device (CCD) sensor or a complementary metal oxide semiconductor (CMOS) sensor.

In the present disclosure, the second reflective interface 214 is obliquely provided relative to the display panel module 100, to reflect the light reflected by the human eye 300 into the light reception unit 220. In some embodiments of the present disclosure, the light reflection unit 210 further includes a third prism 215 and a fourth prism 216 configured to fix the second reflection interface 214, the third prism 215 and the fourth prism 216 are right-angled triangular prisms, an inclined surface of the third prism 215 and an inclined surface of the fourth prism 216 are oppositely provided, and the second reflection interface 214 is fixed on the inclined surfaces of the third prism 215 and the fourth prism 216.

The third prism 215 is provided on a side close to the human eye 300, and the fourth prism 216 is provided on a side close to the display panel module 100. The second reflection interface 214 may transmit visible light and reflect infrared light, a lower surface (a straight corner surface) of the fourth prism 216 is a light incident surface of the visible light emitted by the display panel module 100, and after entering the fourth prism 216, the visible light is transmitted from the inclined surface and transmitted from an upper surface (a straight corner surface) of the third prism 215; the upper surface of the third prism 215 is a light incident surface of the infrared light reflected by the human eye 300, and the infrared light is totally reflected by the second reflective interface 214 of the inclined surface after entering the third prism 215, and is coupled to the light reception unit 220 from the light emitting surface (another straight corner surface) of the third prism 215.

The second reflective interface 214 may be made of a material capable of reflecting infrared light and transmitting visible light (for example, having a high transmittance to visible light), so as not to affect the user viewing the display panel module 100 through the prism. The material of the second reflective interface 214 may be a transparent dielectric material, such as TiO2, SiO2, or a laminate thereof, capable of transmitting visible light and reflecting infrared light. By way of example, the second reflective interface 214 may be formed on the surface of the prism by an evaporation or sputtering process.

The eye tracking optical system provided in the present disclosure further includes a housing 400 for fixing the display panel module 100, the light reflection unit 210 and the light reception unit 220, and the shape and structure of the housing are not limited in the embodiments of the present disclosure. In different embodiments base on different application scenarios, the housing may be a shape of a lens barrel 410, an eyeglass shape, etc., and the lens barrel 410 is exemplarily described in the present disclosure.

For example, the housing 400 may include a lens barrel 410, the lens barrel 410 surrounds to form a sight passage, the lens barrel 410 includes a first end 411 and a second end 412 oppositely provided to each other, where the first end 411 is an end close to the human eye, that is, a field end of the human eye; the display panel module 100 is fixedly provided on the second end 412, and the lens barrels 410 being two are exemplarily described in the present disclosure, two sight passages are formed by the two lens barrels 410, and the two sight passages are respectively configured to view images presented by the display panel module 100 of the left eye and the right eye. In some embodiments, the two lens barrels 410 may share a same wall surface at adjacent positions. The housing 400 may be of an integral structure to ensure the overall strength of the housing 400. The material of the housing 400 includes, but is not limited to, metal, plastic, resin or natural material.

It may be understood that, in the present disclosure, two eye tracking optical systems may be provided on the housing 400 to perform eye tracking on the left eye and the right eye, respectively, each of the two eye tracking optical systems has one display panel module 100, or two eye tracking optical systems share one display panel module 100. In other embodiments, structures of the two eye tracking optical systems may also share other optical elements, such as the light reflection unit 210 or the light emitting unit 240, and in addition, the structures of the two eye tracking optical systems may also be different, which are not specifically limited in the present disclosure.

The light reception unit 220 and the light reflection unit 210 are fixedly provided on a wall surface between the first end 411 and the second end 412 of the lens barrel 410. It may be understood that the light reception unit 220 and the light reflection unit 210 may be provided at any height position of the lens barrel 410. Those skilled in the art may adjust fixed positions of the light reception unit 220 and the light reflection unit 210 as needed.

In addition, it should be noted that words such as “inside” and “outside” in the present disclosure are mainly described in terms of the position of the human eye 300 when the display device is worn on the head of the user, where “inside” refers to being close to the human eye 300, and “outside” refers to being away from the human eye 300. The “inner wall 402 of the lens barrel 410” described in the present disclosure is a wall surface of the lens barrel 410 surrounding the sight passage.

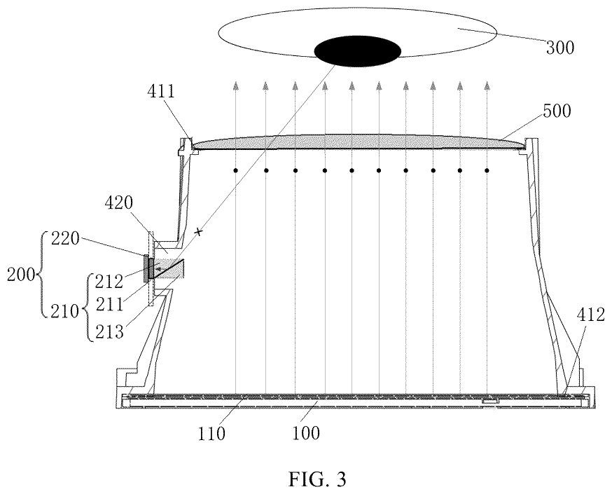

When provided, the light reflection unit 210 is provided on the inner wall 402 of the lens barrel 410 and configured to receive the second light reflected by the human eye. In some embodiments, as shown in FIG. 3, the lens barrel 410 is provided with an accommodating cavity 420 for accommodating the light reflection unit 210, the accommodating cavity 420 protrudes from an inner wall to an outer wall 403 of the lens barrel 410, and a field angle between the human eye 300 and the display panel module 100 is less than or equal to a field angle between the human eye 300 and the light reflection unit 210. Therefore, the optical display device may be simplified, a volume and a weight of the whole optical display system are reduced, and eye is tracked without affecting normal display; the size and weight of the whole head-mounted display device are reduced, and the wearing experience is improved.

To increase the field angle between the human eye 300 and the display panel module 100, at least a part of the inner wall 402 close to the second end 412 of the lens barrel 410 is provided with an inclined wall surface, and the surface is inclined outwards in a direction close to the second end 412, so that the field angle may be increased outwards; in addition, the accommodating cavity 420 may be provided on the inclined wall surface, so that the field angle between the human eye 300 and the light reflection unit 210 may also increase outwards. Since the height of the accommodation cavity 420 on the inner wall 402 is closer to the human eye, the field angle between the human eye 300 and the display panel module 100 is smaller than the field angle between the human eye 300 and the light reflection unit 210, which may track eye without affecting the normal display.

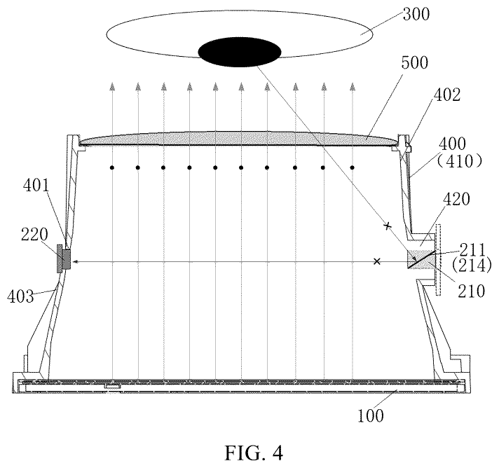

The light reception unit 220 and the light reflection unit 210 may be located on a same side or an opposite side in a radial direction of the lens barrel 410. As shown in FIG. 3, the light reception unit 220 and the light reflection unit 210 are located on the same side of the inner wall of the lens barrel 410, the light reception unit 220 and the light reflection unit 210 are both provided in the accommodating cavity 420, and the light reception unit 220 is fixedly provided on the outer side of the light reflection unit 210 through the optical adhesive; FIG. 4 shows that the light reception unit 220 and the light reflection unit 210 are located on the same side of the inner wall of the lens barrel 410, the light reception unit 220 is provided in the accommodating cavity 420, the light reception unit 220 may be provided on the outer wall 403 of the lens barrel 410 to save the inner space of the lens barrel 410, and light receiving may be achieved by providing the light transmitting hole 401 for transmitting the second light on the lens barrel 410.

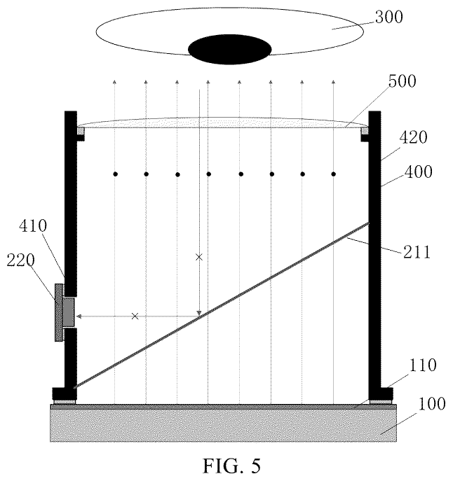

In some other embodiments, as shown in FIG. 5, the light reflection unit 210 (the first reflection interface or the second reflection interface) is provided along a circumferential direction of the inner wall 402 of the housing 400, and an orthographic projection of the light reflection unit 210 on the display panel module 100 coincides with an orthographic projection of the inner wall 402 on the display panel module 100.

In the present disclosure, the first reflective interface 211 is provided on the inner wall 402 of the housing 400 and obliquely provided along the height of the inner wall 402, and a diameter of the orthographic projection of the light reflection unit 210 on the display panel module 100 is equal to a diameter of the inner wall 402. In this embodiment, by increasing an area of the first reflective interface 211, the utilization of light reflected by the human eye 300 is increased, and the accuracy of eye tracking is improved. The first reflective interface 211 includes a first substrate and a plurality layers of dielectric films provided on the first substrate, the second reflective interface 214 includes a second substrate and a dichroic optical coating provided on the second substrate, and a circumferential groove is provided on the inner wall 402 of the housing 400, therefore the first substrate (the second substrate) may be fixed in the groove of the inner wall 402 to achieve a circumferential fixation along the housing 400.

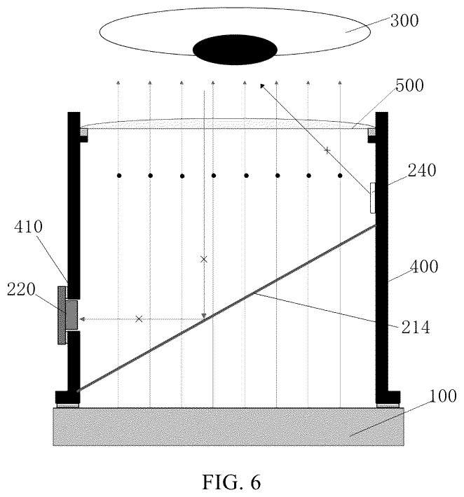

It should be noted that, as shown in FIG. 6, when the second light is infrared light, the light emitting unit 240 may be provided on a side of the light reflection unit 210 close to the human eye 300, to prevent the infrared light emitted from the light emitting unit 240 from entering the light reception unit 220 directly through the second reflective interface 214, thereby affecting eye tracking.

In addition, it may be understood that those skilled in the art may add other optical elements or a combination of the optical elements for adjusting the optical path as needed, to adjust the optical path according to the position of the light reflection unit 210, so that more light reflected by the human eye 300 may enter a light collection unit through the first reflection interface 211, improving the accuracy of eye tracking.

In an embodiment of the present disclosure, the eye tracking optical system further includes a lens module 500 provided between the eye tracking module 200 and the human eye 300, where the lens module 500 includes at least one lens. The first light emitted from the display panel module 100 or the second light emitted by the light emitting unit 240 may be converged by the lens, and the second light reflected by the human eye 300 is transmitted, therefore the normal display requirement may be effectively met and the eye tracking effect may be achieved.

When the eye tracking optical system of the present disclosure is applied to a specific application, after receiving the second light reflected by the human eye 300 through the light reception unit 220, the second light is converted into an electric signal and an image of the human eye 300 is generated based on the electric signal, and a processing unit completes tracking of the eye 300 of the user based on the image of the human eye 300 acquired by the light reception unit 220, where the processing unit may obtain the eye 300 image of the user, and obtain information such as an eyeball gaze position, movement and blinking status of the human eye 300 based on the image of the human eye 300, realizing eye tracking. When applied to an AR/VR display device, the gaze point or focus of the eyeball of the user relative to the display panel module 100 (for example, a touch sensing screen) of the device is tracked in real time. A cursor or focus indicator may be generated on the display panel module 100 based on the tracked gaze point or focus of the eyeball of the user. The generated cursor or focus indicator may be used to select, activate, or interact with a software application, a file, a graphical user interface (GUI), or an icon or object on the GUI to produce a desired action, operation, or effect.

The terms “first” and “second” are used herein for descriptive purposes only and are not to be construed as indicating or implying relative importance or implicitly indicating the number of indicated technical features. Thus, features defining “first”, “second” may explicitly or implicitly include one or more of the features. In the description of the present disclosure, the meaning of “a plurality of” is two or more unless specifically defined otherwise.

In the description of this specification, reference to the description of the terms “an embodiment,” “some embodiments,” “examples,” “specific examples,” or “some examples” or the like means that the specific features, structures, materials, or characteristics described in connection with this embodiment or example are included in at least one embodiment or example of the present disclosure. In this specification, the schematic representation of the above terms does not necessarily refer to the same embodiment or example. Moreover, the specific features, structures, materials, or characteristics described may be combined in any one or more embodiments or examples in a suitable manner. In addition, different embodiments or examples described in this specification and features of different embodiments or examples may be combined without contradicting each other.

Although the embodiments of the present disclosure have been shown and described above, it is to be understood that the above embodiments are exemplary and are not to be construed as limiting the present disclosure, and those skilled in the art may make variations, modifications, substitutions and changes to the above embodiments within the scope of the present disclosure.

I/We claim:

1. An eye tracking optical system, comprising:
a display panel module, configured to emit a first light to a human eye; and
an eye tracking module provided on a light exit side of the display panel module, comprising a light reflection unit and a light reception unit, wherein the light reflection unit is configured to receive a second light reflected by the human eye and couple the second light to the light reception unit, the light reception unit is configured to receive the incident second light to perform eye tracking, and the first light and the second light are different lights.

2. The eye tracking optical system of claim 1, wherein the first light is a first polarized light, the second light is a second polarized light, and a polarization direction of the first polarized light and a polarization direction of the second polarized light are perpendicular;
the light reflection unit comprises a first reflection interface, the first reflection interface comprises a plurality layers of dielectric films, and the first reflection interface is configured to reflect the second polarized light and transmit the first polarized light.

3. The eye tracking optical system of claim 2, wherein the display panel module comprises a display panel and a polarizer provided on a side of the display panel close to a light exit side, and the polarizer is configured to convert a light of the display panel into the first polarized light.

4. The eye tracking optical system of claim 3, wherein the first reflection interface is obliquely provided relative to the display panel, the first reflection interface further comprises a first prism and a second prism configured to fix the first reflection interface, the first prism and the second prism are right-angled triangular prisms, an inclined surface of the first prism and an inclined surface of the second prism are oppositely provided, and the first reflection interface is fixed on the inclined surface of the first prism or the second prism.

5. The eye tracking optical system of claim 1, further comprising:
a light emitting unit, configured to emit the second light to the human eye, wherein the second light is an infrared light; the light emitting unit is provided inside the display panel module or on a light exit side of the display panel module.

6. The eye tracking optical system of claim 5, wherein the light reflection unit comprises a second reflection interface, the second reflection interface comprises a dichroic optical coating, and the second reflection interface is configured to reflect the infrared light and transmit a visible light.

7. The eye tracking optical system of claim 6, wherein the second reflection interface is obliquely provided relative to the display panel, the light reflection unit further comprises a third prism and a fourth prism configured to fix the second reflection interface, the third prism and the fourth prism are right-angled triangular prisms, an inclined surface of the third prism and an inclined surface of the fourth prism are oppositely provided, and the second reflection interface is fixed on the inclined surfaces of the third prism and the fourth prism.

8. The eye tracking optical system of claim 1, further comprising:
a housing, comprising a lens barrel and a first end and a second end oppositely provided on the lens barrel, the first end is an end close to the human eye, the display panel module is fixedly provided at the second end, and the light reception unit and the light reflection unit are both fixedly provided on the lens barrel.

9. The eye tracking optical system of claim 8, wherein the lens barrel is provided with an accommodating cavity for accommodating the light reflection unit, the accommodating cavity protrudes from an inner wall to an outer wall of the lens barrel, and a field angle between the human eye and the display panel module is less than or equal to a field angle between the human eye and the light reflection unit.

10. The eye tracking optical system of claim 9, wherein the light reflection unit and the light reception unit are located on a same side of the lens barrel, and the light reception unit is fixedly provided on an outer side of the light reflection unit through an optical adhesive.

11. The eye tracking optical system of claim 8, wherein the light reflection unit and the light reception unit are located on two opposite sides of the lens barrel in a radial direction, the light reception unit is fixedly provided on an outer wall of the lens barrel, and a light transmitting hole for transmitting the second light is provided on the lens barrel.

12. The eye tracking optical system of claim 8, wherein the light reflection unit is provided along a circumferential direction of an inner wall of the housing, and an orthographic projection of the light reflection unit on the display panel module coincides with an orthographic projection of the inner wall on the display panel module.

13. The eye tracking optical system of claim 1, further comprising:
a lens module, provided between the eye tracking module and the human eye, wherein the lens module comprises at least one lens.

14. A display device, comprising at least one eye tracking optical system comprising:
a display panel module, configured to emit a first light to a human eye; and
an eye tracking module provided on a light exit side of the display panel module, comprising a light reflection unit and a light reception unit, wherein the light reflection unit is configured to receive a second light reflected by the human eye and couple the second light to the light reception unit, the light reception unit is configured to receive the incident second light to perform eye tracking, and the first light and the second light are different lights.

15. The display device of claim 14, wherein the first light is a first polarized light, the second light is a second polarized light, and a polarization direction of the first polarized light and a polarization direction of the second polarized light are perpendicular;
the light reflection unit comprises a first reflection interface, the first reflection interface comprises a plurality layers of dielectric films, and the first reflection interface is configured to reflect the second polarized light and transmit the first polarized light.

16. The display device of claim 15, wherein the display panel module comprises a display panel and a polarizer provided on a side of the display panel close to a light exit side, and the polarizer is configured to convert a light of the display panel into the first polarized light.

17. The display device of claim 16, wherein the first reflection interface is obliquely provided relative to the display panel, the first reflection interface further comprises a first prism and a second prism configured to fix the first reflection interface, the first prism and the second prism are right-angled triangular prisms, an inclined surface of the first prism and an inclined surface of the second prism are oppositely provided, and the first reflection interface is fixed on the inclined surface of the first prism or the second prism.

18. The display device of claim 14, wherein the eye tracking optical system further comprises:
a light emitting unit, configured to emit the second light to the human eye, wherein the second light is an infrared light; the light emitting unit is provided inside the display panel module or on a light exit side of the display panel module.

19. The display device of claim 18, wherein the light reflection unit comprises a second reflection interface, the second reflection interface comprises a dichroic optical coating, and the second reflection interface is configured to reflect the infrared light and transmit a visible light.

20. The display device of claim 19, wherein the second reflection interface is obliquely provided relative to the display panel, the light reflection unit further comprises a third prism and a fourth prism configured to fix the second reflection interface, the third prism and the fourth prism are right-angled triangular prisms, an inclined surface of the third prism and an inclined surface of the fourth prism are oppositely provided, and the second reflection interface is fixed on the inclined surfaces of the third prism and the fourth prism.
